(19) United States
(12) Patent Application Publication
(10) Pub. No.: US 2025/0291126 A1
(43) Pub. Date: Sep. 18, 2025

(54) OPTICAL CONNECTORS WITH INTEGRATED OPTICAL ISOLATORS

(71) Applicant: Intel Corporation, Santa Clara, CA (US)

(72) Inventors: Srikant Nekkanty, Chandler, AZ (US); Wesley Morgan, Lake Oswego, OR (US); Nicholas Psaila, Lanark (GB); David Shia, Portland, OR (US); Eric J.M. Moret, Beaverton, OR (US); Zhichao Zhang, Chandler, AZ (US)

(73) Assignee: Intel Corporation, Santa Clara, CA (US)

(21) Appl. No.: 18/603,309

(22) Filed: Mar. 13, 2024

(51) Int. Cl. G02B 6/38

(52) U.S. Cl. CPC G02B 6/3853

(57) ABSTRACT

Disclosed herein are optical connectors for connecting optical components, along with devices related to optical connectors. An example optical connector includes a body with a first connector interface, a second connector interface opposite the first connector interface, and a surface between the first and second connector interfaces. A cavity extends from the surface into the body. An opening in the body extends from the first connector interface towards the cavity. A portion of the body separates the cavity and the opening.

### BACKGROUND

Photonic integrated circuits (PICs) can be used for several applications, including communications. In order for a PIC to send or receive optical signals to or from an external component or device, optical fibers (or, simply, fibers) of a fiber array unit (FAU) external to the PIC may be connected with the PIC through an optical connector such as a ferrule. Optical signals provided by the fibers inserted into the optical connector can be fed through an optical bridge or a waveguide structure to the PIC.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, not by way of limitation, in the figures of the accompanying drawings.

FIG. 1 is a perspective view of an example optical assembly, in accordance with some embodiments.

FIG. 2 is an exploded perspective view of a portion of the example optical assembly of FIG. 1, in accordance with some embodiments.

FIG. 3 is an exploded perspective view of a portion of FIG. 2, in accordance with some embodiments.

FIG. 4 is a perspective view of an example optical connector holder, in accordance with some embodiments.

FIG. 5A and FIG. 5B are exploded perspective views of an example optical assembly, in accordance with some embodiments.

FIG. 5C is an exploded perspective view of an example optical assembly, in accordance with some embodiments.

FIG. 6 is a perspective view of an example optical assembly, in accordance with some embodiments.

FIG. 7A is a cross-sectional view of an example optical assembly of FIG. 6 taken along plane a, the cross-sectional view further including an optical bridge structure, in accordance with some embodiments.

FIG. 7B, FIG. 7C, and FIG. 7D are cross-sectional views of example optical assemblies, in accordance with various further embodiments.

FIG. 8 is a top view of a wafer and dies that may be included in a microelectronic package or a photonic device that may include an optical assembly or sub-assembly, in accordance with some embodiments.

FIG. 9 is a side, cross-sectional view of an example microelectronic package that may include an optical assembly or sub-assembly, in accordance with some embodiments.

FIG. 10 is a block diagram of a photonic device that may include an optical assembly or sub-assembly, in accordance with some embodiments.

### DETAILED DESCRIPTION

As noted above, optical signals (e.g., light) may be transmitted between a PIC (for example, a PIC die of a co-packaged optical assembly) and an external component or device by fibers of an FAU that are optically connected to the PIC (e.g., through an optical connector and/or an optical bridge structure) and to the external component or device (e.g., through an external component or device connector or coupler). The fibers of the FAU may include a set of fibers designated for transmission of optical signals from the external component to the PIC (e.g., transmit (Tx) fibers). In some cases, the fibers of the FAU may include a set of fibers designated for transmission of optical signals from the PIC to the external component (e.g., receive (Rx) fibers).

In some cases, optical signals transmitted from the external component to the PIC along a Tx fiber may be reflected back along the Tx fiber towards the external component. Light reflected back along the Tx fiber may generate optical interference with the optical signals being transmitted from the external component to the PIC. The optical interference may decrease a signal-to-noise ratio for optical signals transmitted from the external component to the PIC along the Tx fiber, and may lead to inaccurate or poor-quality signals being propagated to the PIC. In some cases, in order to minimize reflections back along a Tx fiber, an optical isolator may be integrated into an optical path between the external component and the PIC (for example, in an architecture of a PIC assembly or co-packaged optical assembly, or elsewhere in the optical path).

An optical isolator may act as an optical diode, substantially permitting the transmission of light passing therethrough only in one direction. One example of an optical isolator is a polarization-dependent isolator that operates only on light having a certain polarization. Another example of an optical isolator is a polarization-independent isolator that operates regardless of the polarization. A typical optical isolator may include one or more polarizers (e.g., an input polarizer and an output polarizer) and a Faraday rotator or another polarization rotator, and, optionally, other components, such as a waveplate.

Integration of an optical isolator into the optical path can be challenging. In some cases, fine alignment of the optical isolator with other optical components in or outside of the optical path (e.g., with a lens component such as a lens of a microlens array, with an optical fiber to be optically interfaced with the optical isolator, with a connector structure, etc.) may necessitate the use of active alignment technology. The use of active alignment technology can involve serial alignment of optical components by repeatedly adjusting positions of the optical components relative to one another, thereby maximizing optical alignment of the optical components across multiple degrees of positional freedom. The use of active alignment technology may require specialized equipment, and active alignment processes may require considerable time to perform, rendering active alignment technology difficult to utilize for high-volume manufacturing of optical assemblies (e.g., photonic assemblies) incorporating optical isolators.

Disclosed herein are optical connectors, along with optical assemblies (e.g. photonic assemblies) and optical systems (e.g., photonic systems) including optical connectors, that aim to address one or more challenges described above. Optical connectors disclosed herein may be integrated into optical paths in a manner that is simpler compared to the approaches described above. An optical path into which an optical connector in accordance with any embodiment disclosed herein may be integrated may extend through the optical connector (e.g., at least a portion of an optical path between a PIC and a component external to the PIC). An example optical connector includes a body with a first connector interface, a second connector interface, and a surface between the first and second connector interfaces, where the second connector interface is opposite the first connector interface. The optical connector includes a cavity extending from the surface into the body, the cavity structured to receive an optical isolator. The optical connector may further include a blind opening in the body extending from the first connector interface towards the cavity, where the blind opening is for receiving a Tx fiber for providing a signal from the first connector interface (the signal transmitted from, for example, an external component to the first connector interface) to the second connector interface (where the signal may be transmitted to, for example, a PIC (e.g., by an optical bridge structure)). The inclusion of a cavity in the body of the optical connector may allow for an optical isolator to be integrated into the body and aligned with the optical path (e.g., with other optical components in the optical path), potentially allowing for improved high-volume manufacturing (e.g., speed and/or efficiency) or assembly of optical assemblies including the optical isolator, and minimizing or eliminating the need for the use of potentially complex active alignment technologies that may require specialized equipment.

The example optical connector may include a lens in the cavity (e.g., one or more lenses, or one or more microlens arrays) aligned with the optical path. The lens may focus or collimate light in the optical path, allowing for optical signals to be transmitted with minimized signal loss. The lens may be integrated into a recess in a sidewall of the cavity, and may be optically aligned with the blind opening (e.g., for receiving the Tx fiber). Recessing the lens in the sidewall of the cavity can prevent the lens from contacting the optical isolator during placement of the optical isolator in the cavity, thereby preventing damage to the lens or preventing undesired displacement of the optical isolator from a desired position or alignment in the cavity (e.g., via the optical isolator tilting or becoming displaced by moving around the lens during placement of the optical isolator in the cavity).

In the following detailed description, reference is made to the accompanying drawings that form a part hereof wherein like numerals designate like parts throughout, and in which is shown, by way of illustration, embodiments that may be practiced. It is to be understood that other embodiments may be utilized, and structural or logical changes may be made, without departing from the scope of the present disclosure. Therefore, the following detailed description is not to be taken in a limiting sense.

Any of the features discussed with reference to any of accompanying drawings herein may be combined with any other features to form an optical assembly 100, a microelectronic package 900, or a photonic device 1000, as appropriate. A number of elements of the drawings with same reference numerals may be shared between different drawings; for ease of discussion, a description of these elements provided with respect to one of the drawings may not repeated for the other drawings, and these elements may take the form of any of the embodiments disclosed herein. The drawings are not necessarily to scale. Although some of the drawings illustrate rectilinear structures with flat walls/surfaces and right-angle corners, this is simply for ease of illustration and may not reflect real-life process limitations which may cause various features to not look so “ideal” when any of the structures described herein are examined using e.g., microscopy images. In such images of real structures, possible processing defects could also be visible, e.g., not-perfectly straight edges of materials, tapered vias or other openings, inadvertent rounding of corners or variations in thicknesses of different material layers. There may be other defects not listed here but that are common within the field of semiconductor device fabrication and packaging. Inspection of layout and mask data and reverse engineering of parts of a device to reconstruct the circuit using e.g., optical microscopy or transmission electron microscopy, and/or inspection of a cross-section of a device to detect the shape and the location of various device elements described herein using, e.g., Physical Failure Analysis (PFA) would allow determination of presence of optical connectors with integrated optical isolators as described herein.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). When used to describe a range of dimensions, the phrase “between X and Y” represents a range that includes X and Y. When used to describe a location of an element, the phrase “between X and Y” represents a region that is spatially between element X and element Y. The terms “substantially,” “close,” “approximately,” “near,” and “about,” generally refer to being within +/−20%, e.g., within +/−5% or within +/−2%, of a target value based on the context of a particular value as described herein or as known in the art. Similarly, terms indicating orientation of various elements, e.g., “coplanar,” “perpendicular,” “orthogonal,” “parallel,” or any other angle between the elements, generally refer to being within +/−10%, e.g., within +/−5% or within +/−2%, of the exact orientation.

The description uses the phrases “in an embodiment” or “in embodiments,” which may each refer to one or more of the same or different embodiments. Furthermore, the terms “comprising,” “including,” “having,” and the like, as used with respect to embodiments of the present disclosure, are synonymous. As used herein, the terms “package” and “integrated circuit (IC) package” are synonymous, as are the terms “die” and “IC die.” Furthermore, the terms “chip,” “chiplet,” “die,” and “IC die” may be used interchangeably herein. Although certain elements may be referred to in the singular herein, such elements may include multiple sub-elements. For example, “an insulator material” may include one or more insulator materials.

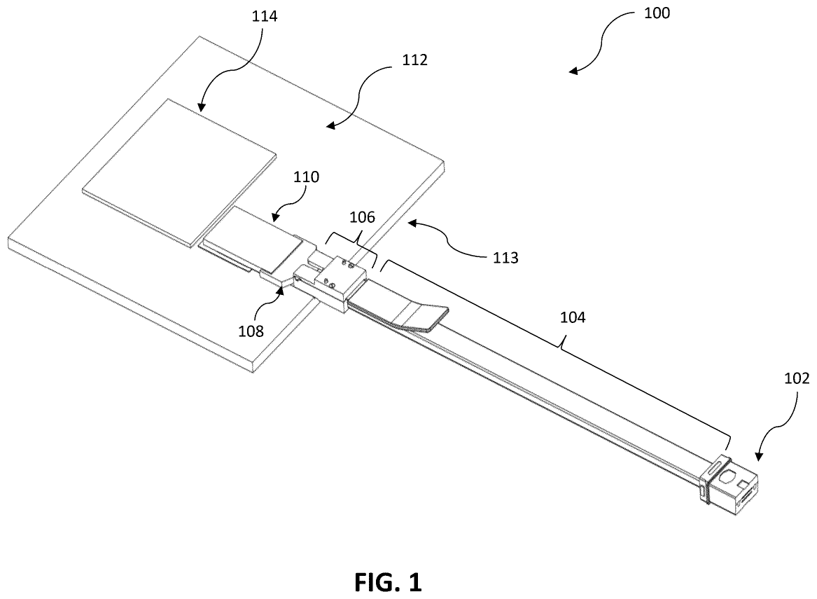

FIG. 1 shows a perspective view of an example optical assembly 100, in accordance with some embodiments. The optical assembly 100 may include an external device coupler 102 configured to join with an external device or component (e.g., an external optical component that can transmit or relay optical signals (e.g., light) to the external device coupler 102, and/or receive optical signals). The external device coupler 102 may be coupled to an optical fiber array assembly or FAU 104 that may channel or relay optical signals from the external device coupler 102 to an optical connector assembly 106. The FAU 104 may include a set of fibers that may be in a protective shell or cover. The optical connector assembly 106 may be coupled to an optical bridge structure 108 (e.g., an optical coupler or optical waveguide structure), which may include one or more channels or waveguides along which optical signals can be channeled or relayed from the optical connector assembly 106 to an optical component 110 (e.g., a PIC die, a receiving component associated with a PIC die, etc.). The optical component 110 is over, and may be mounted to or joined with, a substrate 112 (e.g., a package substrate or PIC substrate). One or more other components 114 (e.g., an xPU such as a central processor unit (CPU), a graphics processing unit (GPU), a tensor processing unit (TPU), a data processing unit (DPU), or another processing unit, a die, or another electronic or photonic component) may also be over the substrate 112. In some embodiments, as shown, part or all of the optical connector assembly 106 may be over an end or edge 113 of the substrate 112, or may be joined or mounted to the end or edge 113 of the substrate 112. In other embodiments, the optical connector assembly 106 may be mounted within the end or edge 113 of the substrate 112, or may be mounted away from the end or edge 113 of the substrate 112. In some embodiments, the optical connector assembly 106 may be attached or mounted to a support outside of the substrate 112.

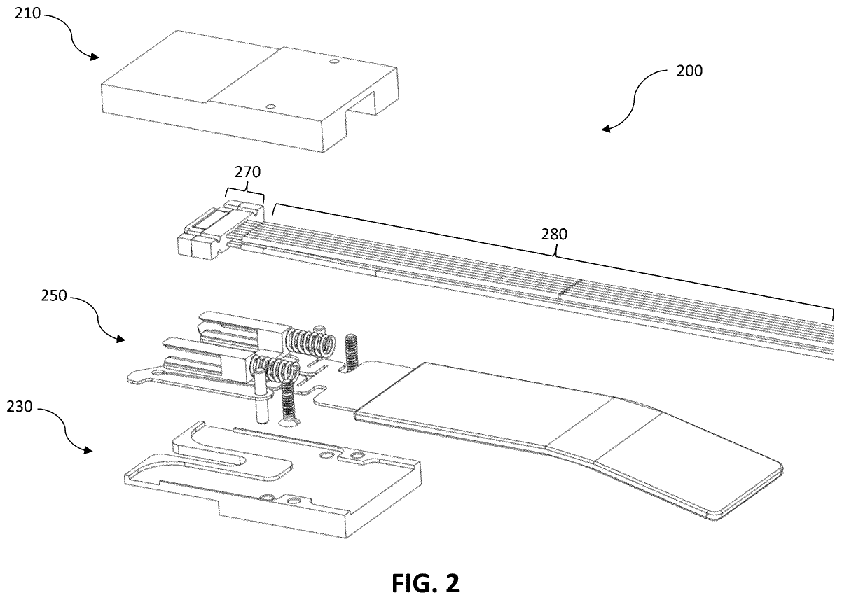

FIG. 2 shows an exploded perspective view of a portion 200 of the example optical assembly 100 of FIG. 1 (also referred to as an optical assembly 200). As shown, the optical assembly 200 may include a set of optical fibers 280 (e.g., optical fibers of the FAU 104). The set of optical fibers 280 may be received in an optical connector 270. On a first side of the optical connector 270 (e.g., over the optical connector 270) may be a first connector housing portion 210, and on a second side of the optical connector 270 (e.g., under the optical connector 270) may be a second connector housing portion 230. In between the first connector housing portion 210 and the second connector housing portion 230 may be a third connector housing portion 250. The first, second, and third connector housing portions 210, 230, 250 and the optical connector 270 may be components or portions of the optical connector assembly 106.

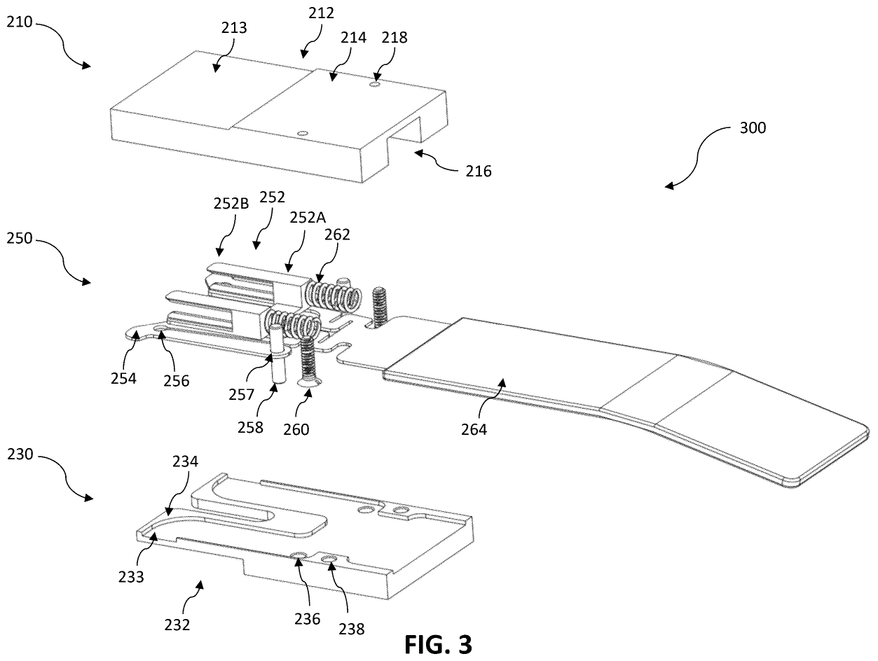

FIG. 3 shows a portion of the example optical assembly 200 of FIG. 2 (also referred to as an optical assembly 300), including the first connector housing portion 210, the second connector housing portion 230, and the third connector housing portion 250. The first connector housing portion 210 may include a body 212 with a step portion 213 and a raised portion 214. The first connector housing portion 210 may also include a slot 216 (e.g., in the raised portion 214) for receiving optical fibers (e.g., the set of optical fibers 280) and apertures 218 for fasteners 260. The second connector housing portion 230 may include a body 232 with a step portion 233 and a raised portion 234. The second connector housing portion 230 may also include apertures 236 (e.g., in the step portion 233) for alignment elements 258 and apertures 238 or fasteners 260.

The third connector housing portion 250 may include a spring platform 254 including cut-outs 256. The spring platform 254 may include apertures 257 for alignment elements 258. A pull tab 264 may be secured to the spring platform 254. An optical connector holder 252 having a first optical connector holder end 252A and a second optical connector holder end 252B may be over the spring platform 254.

The first, second, and third connector housing portions 210, 230, 250 and the optical connector 270 may be brought together to form an optical connector assembly (e.g., the optical connector assembly 106 shown in FIG. 1). In particular, the first connector housing portion 210 (shown at a bottom of the assembled optical connector assembly 106 of FIG. 1, or on a side of the optical connector assembly 106 closest to the substrate 112) may be joined to the second connector housing portion 230 (shown at a top of the assembled optical connector assembly 106 of FIG. 1, or on a side of the optical connector assembly 106 furthest from the substrate 112) by fasteners 260. The third connector housing portion 250 may be fitted between the first connector housing portion 210 and the second connector housing portion 230. The spring platform 254 of the third connector housing portion 250 may be aligned with the second connector housing portion 230 using alignment elements 258 (e.g., alignment rods) that may extend through the apertures 257 in the spring platform 254 and the apertures 236 in the step portion 233 of the second connector housing portion 230, and the spring platform 254 may be placed over the step portion 233 of the second connector housing portion 230. After bringing the first, second, and third connector housing portions 210, 230, 250 together, one or more resilient or biasing members 262 (e.g., springs) may be between the first optical connector holder end 252A of the optical connector holder 252 and a wall (not shown) in the body 212 of the first optical connector housing portion 210.

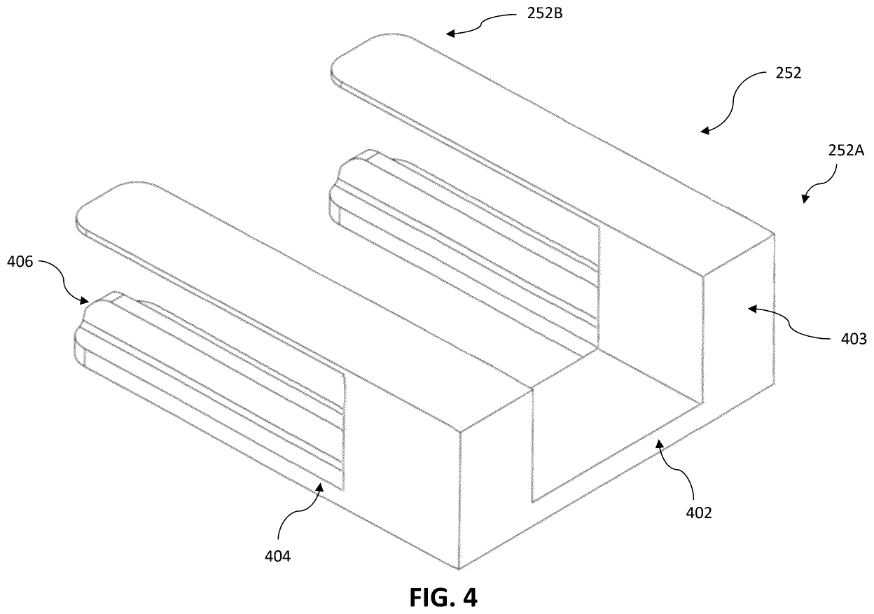

FIG. 4 shows a perspective view of the optical connector holder 252, in accordance with some embodiments. The optical connector holder 252 may include a body with a U-shape. The U-shape body may include a base 402 and pair of columns 403 on opposing ends of the base 402, the columns 403 extending in a direction substantially perpendicular to the base 402. Pairs of connector holder arms 404 may extend from ends of the columns 403 (e.g., top and bottom ends as shown in FIG. 4) between the first and second optical connector holder ends 252A, 252B. The connector holder arms 404 may include raised holder portions 406 that project outwardly from the connector holder arms 404 in a direction substantially perpendicular to the direction along which the connector holder arms 404 extend.

In use, the assembly of the first, second, and third connector housing portions 210, 230, 250 and the optical connector 270 (e.g., together, the optical connector assembly 106 of FIG. 1) may be placed over the edge 113 of the substrate 112 (e.g., such that the step portion 213 of the body 212 of the first connector housing portion 210 rests over the edge 113 of the substrate 112). The optical connector holder 252 may hold the optical connector 270 (e.g., via engagement between raised holder portions 406 and alignment grooves of the optical connector 270, further described below). The set of optical fibers 280 may interface with the optical connector 270, and may extend through the slot 216 in the first connector housing portion 210. The optical connector 270 may be coupled with an optical bridge structure (e.g., the optical bridge structure 108). The optical connector 270 may be allowed to move in the assembly during a process of coupling the optical connector 270 and the optical bridge structure. In particular, during the process of coupling, the optical connector holder 252 holding the optical connector 270 may be urged against the one or more resilient or biasing members 262 between the first optical connector holder end 252A and a wall in the body 212 of the first optical connector housing portion 210, causing the resilient or biasing members 262 to move or compress. The movement or compression of the resilient or biasing members 262 can permit movement of the optical connector 270 relative to the optical bridge structure, and can facilitate engagement between the optical connector 270 and the optical bridge structure. Additionally, the spring platform 254 of the third connector housing portion 250 may permit the optical connector holder 252 holding the optical connector 270 to move slightly into a position for alignment between the optical connector 270 and the optical bridge structure if the optical connector 270 and the optical bridge structure are slightly misaligned during the process of coupling. In some embodiments, the pull tab 264 of the third connector housing portion 250 may be manipulated to move the assembly of the first, second, and third connector housing portions 210, 230, 250 and the optical connector 270 towards an optical bridge structure for coupling, or may be manipulated to move the assembly of the first, second, and third connector housing portions 210, 230, 250 and the optical connector 270 away from an optical bridge structure for decoupling.

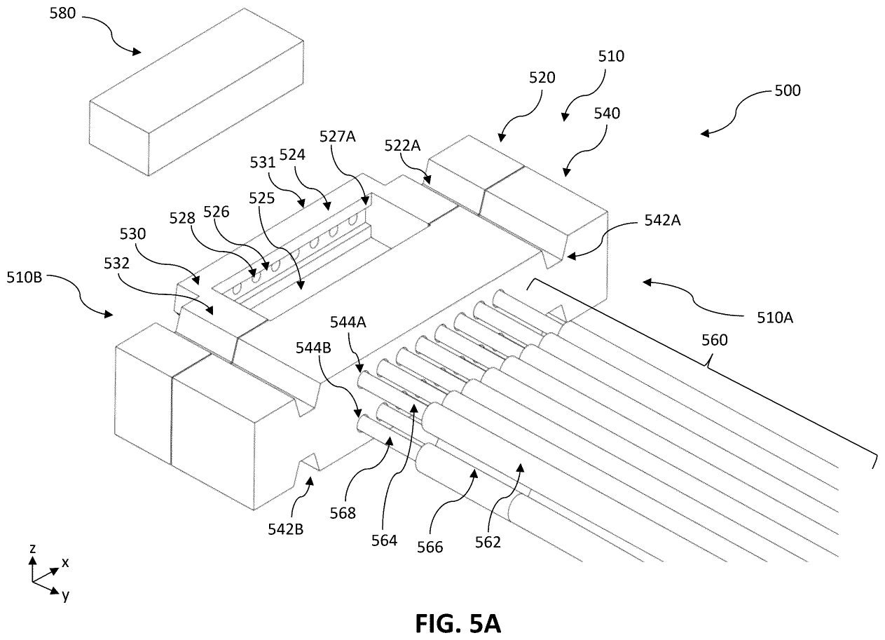

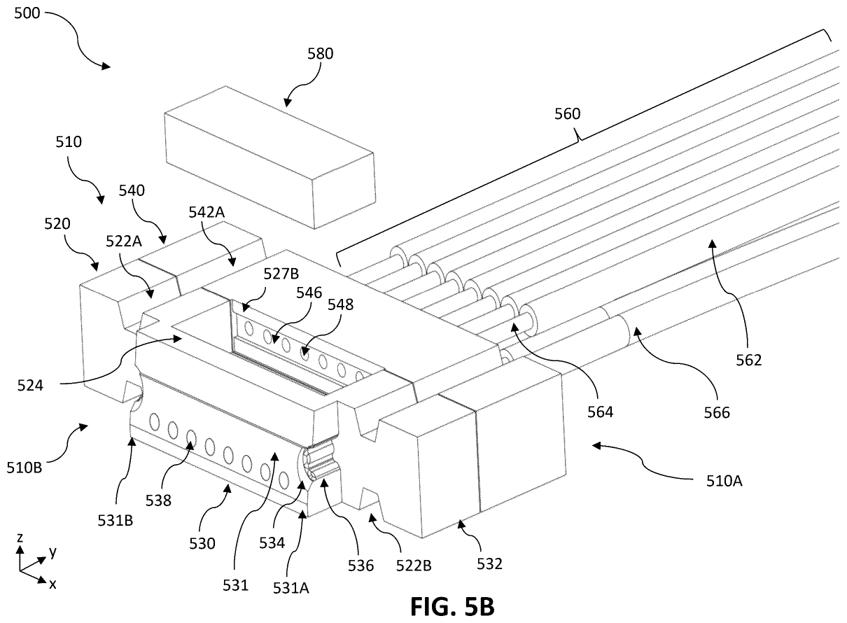

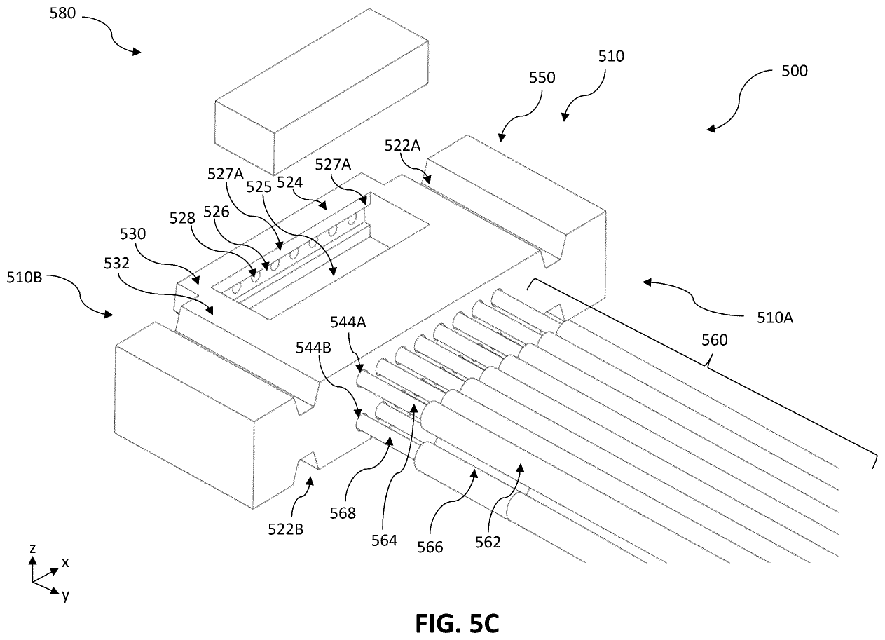

FIG. 5A and FIG. 5B show exploded perspective views of an example optical assembly 500, in accordance with some embodiments. The example optical assembly 500 includes an optical connector 510, which may be the same as or similar to the optical connector 270 shown in FIG. 2, and a set of optical fibers 560, which may be the same as or similar to the set of optical fibers 280 shown in FIG. 2.

The optical connector 510 may include a body or structure that may include a first connector interface 510A (e.g., a first or back side or end) and a second connector interface 510B (e.g., a second or front side or end). The body may be optically transparent to optical signals (e.g., light) received from or channeled to the set of optical fibers 560, or one or more parts of the body aligned with one or more optical paths extending between the set of optical fibers 560 and an optical bridge structure or optical component interfacing with the body (e.g., the optical bridge structure 108 and/or optical component 110 shown in FIG. 1) may be optically transparent to optical signals.

The body of the optical connector 510 may include multiple portions, including a first portion 520 and a second portion 540. The first portion 520 may include a first section 530 (e.g., a leading or front section) and a second section 532 (e.g., a trailing or rear section). The first section 530 may have a width (e.g., along the x-axis as shown in FIG. 5A and FIG. 5B) that is smaller than a width of the second section 532. As shown in FIG. 5B, the first section 530 may include a front surface 531 with a pair of ends 531A, 531B. At the ends 531A, 531B may be chamfers 534 extending from the front surface 531 towards alignment recesses 536 that may extend towards the second section 532. The alignment recesses 536 may be used to align the optical connector 510 with an optical bridge structure having complementary alignment features (e.g., the optical bridge structure 108 shown in FIG. 1). The first portion 520 may also include a set of apertures or openings 538. The openings 538 may be for optical fibers (e.g., a portion of the optical fibers 560). The second section 532 may also include a set of first (e.g., top) alignment grooves 522A and a set of second (e.g., bottom) alignment grooves 522B. The first alignment grooves 522A and the second alignment grooves 522B may interface with an optical connector holder (e.g., the raised holder portions 406 of the connector holder arms 404 of the optical connector holder 252 shown in FIG. 4), as described further later in this specification.

The second portion 540 of the body of the optical connector 510 may include a set of first (e.g., top) alignment grooves 542A and a set of second (e.g., bottom) alignment grooves 542B. The sets of first and second alignment grooves 542A, 542B of the second portion 540 may be similar to the sets of first and second alignment grooves 522A, 522B of the first portion 520, and may be aligned with the sets of first and second alignment grooves 522A, 522B of the first portion 520. The second portion 540 may also include one or more first openings 544A (e.g., first apertures or channels) and one or more second openings 544B (e.g., second apertures or channels). The first openings 544A and the second openings 544B may be for optical fibers (e.g., the optical fibers 560). In particular, the first and second openings 544A, 544B may be for receiving optical fibers for transmitting optical signals between the first connector interface 510A and the second connector interface 510B.

The body of the optical connector 510 may include a cavity 524 (e.g., a blind hole or a blind shaft). The cavity 524 may extend from a surface (e.g., outer portion) of the body of the optical connector 510, the surface between the first connector interface 510A and the second connector interface 510B. The cavity 524 may extend from the surface to a bottom or floor 525 in the body. The cavity 524 may be at a non-zero distance from both the first connector interface 510A and the second connector interface 510B.

The cavity 524 may include a first sidewall 527A in the body of the optical connector 510 (e.g., between the surface of the body and the floor 525 of the cavity 524). The first sidewall 527A may be substantially perpendicular to the surface between the first and second connector interfaces 510A, 510B (e.g., substantially parallel to the z-axis line as shown in FIG. 5A and FIG. 5B). One or more first lenses 528 (e.g., one or more first microlenses, or a first microlens array) may be in the cavity 524. In particular, the first lenses 528 may be at the first sidewall 527A of the cavity 524. The first lenses 528 may be in a first recess 526 (e.g. a first alcove) of the first sidewall 527A. The first recess 526 may have a depth of between about 1 and about 100 microns, or between about 1 and about 50 microns, or between about 5 and about 30 microns, or any ranges or sub-ranges therebetween. The first sidewall 527A may be a wall of the first portion 520 (e.g., a recessed wall of the first portion 520) of the optical connector 510. The first lenses 528 may include, for example, a resin or a glass material. In some embodiments, the first lenses 528 may be integrated into the first sidewall 527A. For example, the first lenses 528 may be a part of, or integral with, the first sidewall 527A, and may include lenticular structures that extend in a convex fashion from the first sidewall 527A into the cavity 524. In some embodiments, the first lenses 528 may be separate from the first sidewall 527A, and may be attached or fixed to the first sidewall 527A (e.g., via an adhesive).

The cavity 524 may include a second sidewall 527B in the body of the optical connector 510 (e.g., between the surface of the body and the floor 525 of the cavity 524). The second sidewall 527B may be substantially perpendicular to the surface between the first and second connector interfaces 510A, 510B (e.g., substantially parallel to the z-axis line as shown in FIG. 5A and FIG. 5B). The second sidewall 527B may be substantially parallel to the first sidewall 527A, and may oppose the first sidewall 527A (e.g., the second sidewall 527B may be on an opposed side of the cavity 524 from the first sidewall 527A). One or more second lenses 548 (e.g., one or more second microlenses, or a second microlens array) may be in the cavity 524. In particular, the second lenses 548 may be at the second sidewall 527B of the cavity 524. The second lenses 548 may be in a second recess 546 (e.g., second alcove) of the second sidewall 527B. The second recess 546 may have a depth between about 1 and about 100 microns, or between about 1 and about 50 microns, or between about 5 and about 30 microns, or any ranges or sub-ranges therebetween. The depth of the second recess 546 may be substantially the same as or substantially similar to the depth of the first recess 526, or the depth of the second recess 546 may be different from the depth of the first recess 526. The second sidewall 527B may be a wall of the second portion 540 (e.g., a recessed wall of the second portion 540) of the optical connector 510. The second lenses 548 may include, for example, a resin or a glass material. In some embodiments, the second lenses 548 may be integrated into the second sidewall 527B. For example, the second lenses 548 may be a part of, or integral with, the second sidewall 527B, and may include lenticular structures that extend in a convex fashion from the second sidewall 527B into the cavity 524. In some embodiments, the second lenses 548 may be separate from the second sidewall 527B, and may be attached or fixed to the second sidewall 527B (e.g., via an adhesive). One or more of the second lenses 548 may be substantially aligned (e.g., optically aligned) with one or more of the first lenses 528. In other words, optical axes of one or more of the second lenses 548 may be aligned (i.e., optically aligned) with optical axes of one or more of the first lenses 528. The second lenses 548 may have substantially the same shape or configuration as the first lenses 528, or the second lenses 548 may have one or more different shapes or configurations.

An optical isolator 580 may be in the cavity 524. The optical isolator 580 may include any suitable configuration or structure that may allow the optical isolator 580 to act as an optical diode, substantially permitting the transmission of light passing therethrough in only one direction (e.g., from the first connector interface 510A to the second connector interface 510B). In some embodiments, the optical isolator 580 may include one or more polarizers (e.g., an input polarizer and an output polarizer) and a Faraday rotator or another polarization rotator. The optical isolator 580 may also include one or more other components including a lens, a waveplate, a slit, a mirror, a prism, a light absorber (e.g., a wavelength selective light absorber), or another film or plate. The optical isolator 580 shown in various figures (including FIG. 5A and FIG. 5B) has a substantially rectangular cuboid or rectangular parallelepiped (i.e., orthogonal parallelepiped) shape, and the cavity 524 has a complementary substantially rectangular cuboid or rectangular parallelepiped shape. However, other shapes may be contemplated for the optical isolator 580 and the cavity 524 (e.g., the shapes of the optical isolator 580 or one or more components of the optical isolator 580 depending on the makeup and configuration of the optical isolator 580). For example, in some embodiments, the optical isolator 580 or the cavity 524 may be substantially cube-shaped, or have another prism shape. In some embodiments, the optical isolator 580 or the cavity 524 may be cylinder-shaped, and the cavity 524 may only include one sidewall. In some embodiments, the shapes of the cavity 524 and the optical isolator 580 may be dissimilar.

The optical isolator 580 may be placed in the cavity 524 and secured in the cavity 524. For example, an adhesive may be placed over the floor 525 and/or sidewalls 527A, 527B of the cavity 524, and the optical isolator 580 may be placed over the adhesive. The adhesive may include any material suitable for fixing the optical isolator 580 in the cavity 524, such as a glue, an epoxy material (e.g., an ultraviolet (UV)-curable epoxy that, upon exposure to UV radiation after deposition, cross-links in place), a polyester, a polyimide, or an acrylic material. After the optical isolator 580 is placed in the cavity 524, if a gap (e.g., an air gap) exists between the optical isolator 580 and the sidewalls 527A, 527B, between the optical isolator 580 and the surface of the body of the optical connector 510 (e.g., the surface from which the cavity 524 extends), and/or between the optical isolator 580 and the floor 525, the gap may be filled with a filler material. The filler material may include any suitable material, including an organic polymer or resin. The filler material may be substantially optically transparent. The filler material may have a refractive index that contrasts with a refractive index of the body of the optical connector 510 as described in further detail later in this disclosure. In some embodiments, no filler material may be present.

The set of optical fibers 560 may include one or more first optical fiber structures corresponding to Tx fibers, which may include first optical fibers 564 and first optical fiber sheaths 562. The one or more first optical fibers 564 may be used to channel or relay optical signals or light (e.g. from an external device or component optically coupled to the first optical fibers 564 by the external device coupler 102 shown in FIG. 1) towards an optical bridge structure or optical component (e.g., the optical bridge structure 108 and/or optical component 110 shown in FIG. 1). The first optical fibers 564 may be placed in or optically interfaced with the first openings 544A of the second portion 540 of the body of the optical connector 510. The first openings 544A may be substantially aligned (e.g., optically aligned, or having aligned optical axes) with the first and/or second lenses 528, 548. In other words, the first and/or second lenses 528, 548 may have optical axes aligned with optical axes of the first optical fibers 564 to be placed in or optically interfaced with the first openings 544A. The first openings 544A may extend from the first connector interface 510A towards the cavity 524. A portion of the body of the optical connector 510 may separate the cavity 524 and the first openings 544A. In other words, the first openings 544A may be blind openings extending into the body of the optical connector 510 from the first connector interface 510A.

A distance between the cavity 524 and one or more of the first openings 544A may be between about 1 and about 100 microns, or between about 1 and about 50 microns, or between about 5 and about 30 microns, or any ranges or sub-ranges therebetween. The distance between the cavity 524 and one or more of the first openings 544A may be between about 1% and about 25% of a distance between the first connector interface 510A and the second connector interface 510B, or between about 1% and about 25%, or between about 5% and about 10%. The first sidewall 527A of the cavity 524 may be closer to the first openings 544A than the second sidewall 527B of the cavity 524. The first lenses 528 may be at the first sidewall 527A (e.g., at the first recess 526 of the first sidewall 527A), which may be closer to the second connector interface 510B than the first connector interface 510A. The second lenses 548 may be at the second sidewall 527B (e.g., at the second recess 546 of the second sidewall 527B), which may be closer to the first connector interface 510A than the second connector interface 510B.

The set of optical fibers 560 may also include one or more second optical fiber structures corresponding to Rx fibers, which may include second optical fibers 568 and second optical fiber sheaths 566. The one or more second optical fibers 568 may be used to channel or relay optical signals or light (e.g., from the optical bridge structure 108 and/or optical component 110 shown in FIG. 1) towards the external device or component optically coupled to the external device coupler 102 shown in FIG. 1. The second optical fibers 568 may be placed in or optically interface with the second openings 544B of the second portion 540 of the body of the optical connector 510.

Although FIG. 5A and FIG. 5B show that the body of the optical connector 510 may include two portions, in some embodiments, the body of the optical connector 510 may include more than two portions (e.g., a third portion, a fourth portion, etc.). In some embodiments, as shown in FIG. 5C, which depicts an exploded perspective view of an alternative example optical assembly, the body of the optical connector 510 may include a single portion or body 550. In other words, the body 550 of the optical connector 510 may be a monolithic body or monolithic structure. The same features of the first portion 520 and the second portion 540 of FIG. 5A and FIG. 5B, or features similar to those features on the first portion 520 and the second portion 540, may be included on or in the body 550. For example, the body 550 may include first and second alignment grooves 522A, 522B along a surface of the body 550 extending between the first connector interface 510A and the second connector interface 510B, where the first and second alignment grooves 522A are substantially similar to the first and second alignment grooves 522A, 522B of the first portion 520 of the optical connector 510 and the first and second alignment grooves 542A, 542B of the second portion of the optical connector 510 as shown in FIG. 5A and FIG. 5B. As another example, the cavity 524 in the body of the optical connector 510 as shown in FIG. 5B may be the same as the cavity 524 in the body 550.

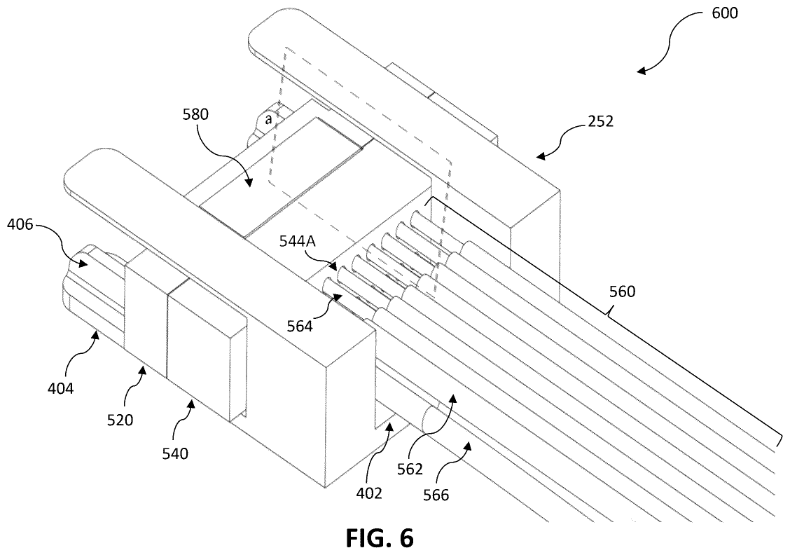

The second portion 540 of the body of the optical connector 510 may be attached to or fixed in alignment with the first portion 520 of the body of the optical connector 510. In particular, as shown in FIG. 6, the first portion 520 may abut the second portion 540 such that the first alignment grooves 522A and the second alignment grooves 522B of the body of the optical connector 510 are aligned. The optical connector holder 252 may be placed around the abutted first and second portions 520, 540 such that the raised holder portions 406 of the connector holder arms 404 of the optical connector holder 252 may be placed in the first alignment grooves 522A and the second alignment grooves 522B, fixing the alignment of the first portion 520 relative to the second portion 540. The optical connector holder 252 and the first and second portions 520, 540 of the body of the optical connector 510 may be held within an optical connector housing (e.g., the first, second, and third connector housing portions 210, 230, 250 as shown in FIG. 2).

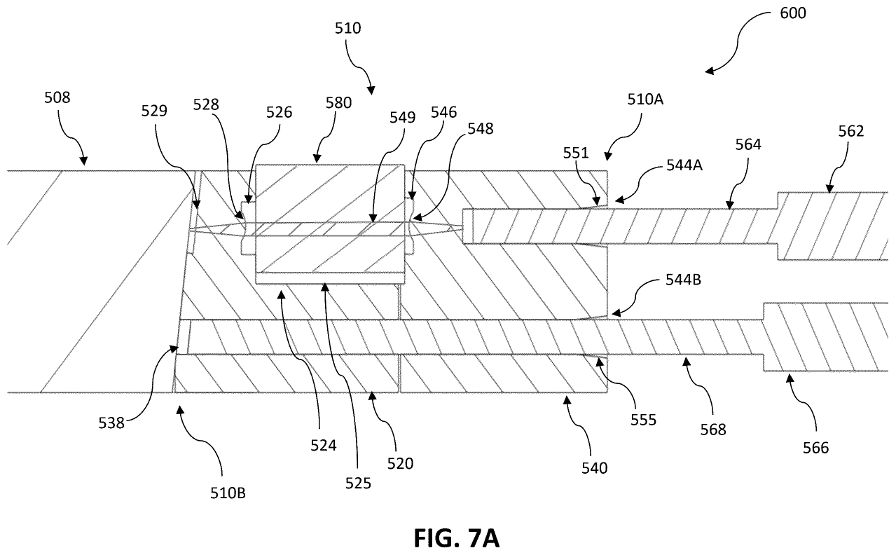

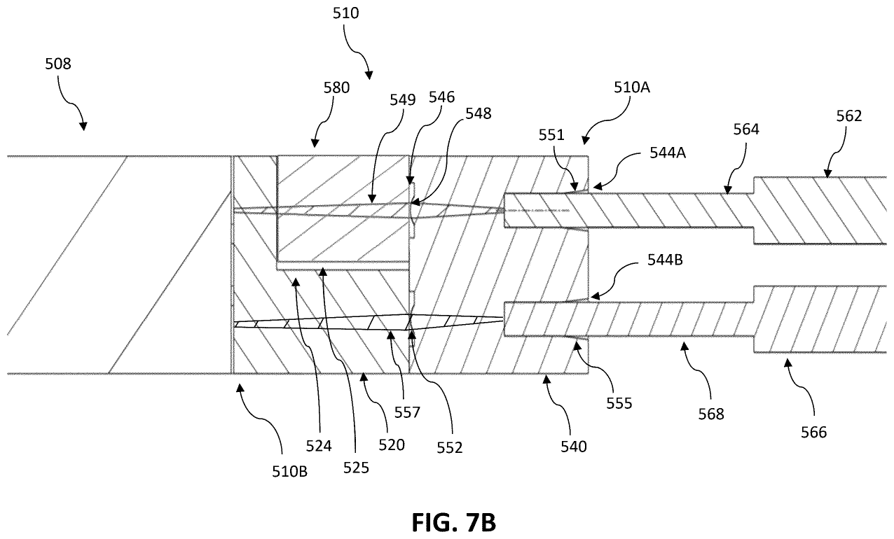

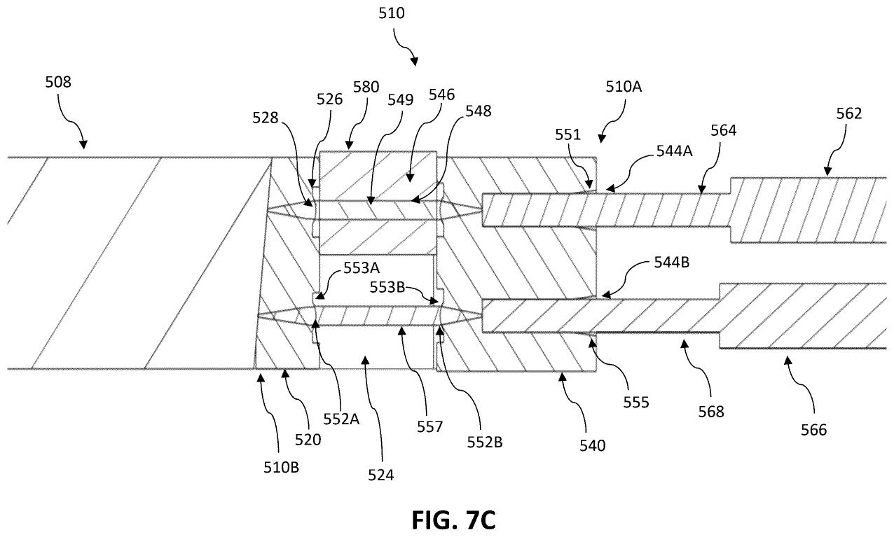

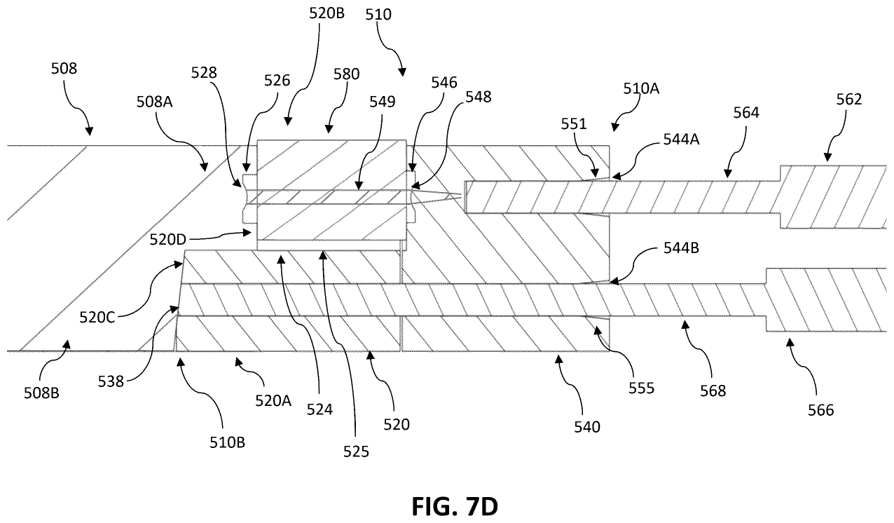

FIG. 7A shows a cross-sectional view of the example optical assembly 600 of FIG. 6 taken along plane a, the cross-sectional view further showing an optical bridge structure 508. As shown in FIG. 7A, first optical fibers 564 (e.g., corresponding to Tx fibers) may be in the first openings 544A of the second portion 540 of the body of the optical connector 510, and second optical fibers 568 (e.g., corresponding to Rx fibers) may be in the second openings 544B of the second portion 540 of the body of the optical connector 510. The first openings 544A and the second openings 544B may extend from the first connector interface 510A of the optical connector 510 and towards the optical bridge structure 508, which may be the same as the optical bridge structure 108 shown in FIG. 1. Chamfered or beveled surfaces 551, 555 may extend from the first connector interface 510A towards the first openings 544A and second openings 544B. The chamfered surfaces 551, 555 may facilitate a process of insertion of the first optical fibers 564 and the second optical fibers 568 to corresponding first openings 544A and second openings 544B. For example, if a first optical fiber 564 is slightly misaligned with a first opening 544A such that it touches a chamfered surface 551 during insertion, the first optical fiber 564 may slide along the chamfered surface 551 during insertion until it is aligned with the first opening 544A.

The first openings 544A may extend from the first connector interface 510A towards the cavity 524, and as noted above, the first openings 544A may be blind openings (e.g., a portion of the body of the optical connector 510 may separate the cavity 524 and the openings 544A). The optical isolator 580 is shown in the cavity 524. Although FIG. 7A shows a gap between the optical isolator 580 and the floor 525 of the cavity 524, as described above, the gap may be filled with a filler material. In some embodiments, the optical isolator 580 may contact the floor 525 of the cavity 524. Additionally, although FIG. 7A shows that a portion of the optical isolator 580 in the cavity 524 rests above the surface of the body of the optical connector 510 between the first connector interface 510A and the second connector interface 510B, in some embodiments, the optical isolator 580 may be flush with the surface, or may be under the surface (where a gap between the surface and the optical isolator 580 may be filled with a filler material as described above).

As shown in FIG. 7A, the second openings 544B may extend through the body of the optical connector 510 (e.g., between the first connector interface 510A and the second connector interface 510B) to the apertures or openings 538 in the first portion 520 of the body of the optical connector 510. The second openings 544B may not intersect with the cavity 524. For example, as shown in FIG. 7A, the second openings 544B extend through the body of the optical connector 510 under the cavity 524, and the second optical fibers 568 extend through the second openings 544B such that the second optical fibers 568 are proximal to the optical bridge structure 508. In some embodiments, the second optical fibers 568 may touch or contact the optical bridge structure 508.

An optical path may extend between the first connector interface 510A and the second connector interface 510B. In particular, along the optical path, optical signals 549 may be transmitted from first optical fibers 564 in the first openings 544A through a portion of the body of the optical connector 510 and through second lenses 548 in the second recess 546 of the cavity 524. The optical signals 549 may be transmitted from the second lenses 548 and through the optical isolator 580 in the cavity 524 towards the first lenses 528. The optical signals 549 may be transmitted through the first lenses 528 and through another portion of the body of the optical connector 510 towards the optical bridge structure 508 (e.g., towards channels or waveguides (not shown) in the optical bridge structure 508). The first lenses 528, second lenses 548, and first openings 544A may be physically and/or optically aligned (e.g., the first and second lenses 528, 548 and first openings 544A may have optical axes aligned with an optical axes of the first optical fibers 564 placed in or optically interfaced with the first openings 544A). The optical isolator 580, or components of the optical isolator 580, may be physically and/or optically aligned with the first lenses 528, second lenses 548, and/or first openings 544A. The shape, size, configuration, and/or material of the first lenses 528, second lenses 548, and optical isolator 580 may be selected such that optical signals 549 are collimated, diffused, and/or focused as needed for a given application, or to allow for optical signals 549 of a desired quality or character to be obtained (e.g., at the optical bridge structure 508). In some embodiments, additional sets of lenses (e.g., in addition to the first lenses 528 and second lenses 548) may be present (e.g., for collimation, diffusion, and/or focusing optical signals), or only one set of lenses (e.g., the first lenses 528 or the second lenses 548) may be included in the optical connector 510 (e.g., in the cavity 524).

Additionally, as noted earlier in this disclosure, a refractive index of a filler material filling a gap around the optical isolator 580 in the cavity 524 (e.g., between the optical isolator 580 and the first and/or second sidewalls 527A, 527B, the optical isolator 580 and the floor 525, and/or the optical isolator 580 and/or the surface of the body of the optical connector 510 between the first and second connector interfaces 510A, 510B) may be selected such that optical signals 549 are collimated, diffused, and/or focused as needed for a given application, or to allow for optical signals 549 of a desired quality or character to be obtained. The refractive index of the filler may, for example, be different from a refractive index of a material in the body of the optical connector 510, or different from a refractive index of the first and/or second lenses 528, 548, or different from a component of the optical isolator 580.

The second connector interface 510B may include a depression 529 (e.g., a step feature, shown as a gap between the second connector interface 510B and the optical bridge structure 508). The depression 529 may extend from the surface of the body of the optical connector 510 between the first connector interface 510A and the second connector interface 510B, and may extend from the second connector interface 510B into the body of the optical connector 510 (a portion of the body separating the depression 529 and the cavity 524). The depression 529 may be substantially physically and/or optically aligned with the first lenses 528, second lenses 548, optical isolator 580, and/or first openings 544A (e.g., optical axes of the depression 529, first lenses 528, second lenses 548, optical isolator 580, and/or first openings 544A may be aligned). A depth of the depression 529 (e.g. the depth to which the depression 529 extends from the second connector interface 510B into the body of the optical connector 510) may be between about 1 and about 100 microns, or between about 1 and about 50 microns, or between about 1 and about 25 microns, or between about 1 and about 10 microns, or any ranges or sub-ranges therebetween. In some embodiments, the depth of the depression 529 may be between about 1% and about 50% of a length of the second connector interface 510B, or between about 1% and about 25% of the length, or between about 1% and about 10% of the length, or any ranges or sub-ranges therebetween. The depression 529 may be advantageously included if the second optical fibers 568 extend through the second openings 544B and are to be polished at the second connector interface 510B in order to clean or shape the second optical fibers 568 to allow for a good interface or connection between the second optical fibers 568 and the optical bridge structure 508. In particular, when polishing the second optical fibers 568 at the second connector interface 510B, the depression 529 may prevent the polishing of a portion of the second connector interface 510B in the optical path of the optical signals 549 (e.g., the first and second lenses 528, 548, the optical isolator 580, and first openings 544A being along the optical path as described above), which can preserve the surface of the portion of the second connector interface 510B and prevent polishing-related degradation of optical signals 549 passing therethrough. In some embodiments, no depression may be present.

In some embodiments, the second openings 544B may only extend partway through the body of the optical connector 510 (e.g., the second openings 544B may be blind openings). For example, as shown in FIG. 7B, which depicts a cross-sectional view of an alternative example optical assembly, the second optical fibers 568 (e.g., Rx fibers) may be in blind second openings 544B. Optical signals 557 may be transmitted along an optical path, along which the optical signals 557 may be transmitted from the optical bridge structure 508 to the second optical fibers 568. The optical signals 557 may be transmitted from the optical bridge structure 508 and through a portion of the body of the optical connector 510, passing through a lens 552 in the body. The lens 552 may focus the optical signals 557, which may diverge as they move towards the lens 552. The optical signals 557 may be transmitted from the portion of the body of the optical connector 510 to the second optical fibers 568. As shown, the cavity 524 may also include only one set of lenses 548 (e.g., in recess 546).

In some embodiments, the second openings 544B may intersect with the cavity 524. For example, as shown in FIG. 7C, which depicts a cross-sectional view of an alternative example optical assembly, the cavity 524 (e.g., hole or shaft) may extend through the body of the optical connector 510 (e.g., the cavity 524 may not have a floor). As described earlier with reference to FIG. 7B, second optical fibers 568 may be in blind second openings 544B (with a further portion of the body of the optical connector 510 separating the cavity 524 and the second openings 544B), and optical signals 557 may be transmitted along an optical path, along which optical signals 557 may be transmitted from the optical bridge structure 508 to the second optical fibers 568. The optical signals 557 may be transmitted from the optical bridge structure 508 and through a portion of the body of the optical connector 510 (e.g., part of the first portion 520 of the body of the optical connector 510). The optical signals 557 may be transmitted from the portion of the body of the optical connector 510 and through the cavity 524, including through lenses 552A and 552B (e.g., in corresponding recesses 553A and 553B in sidewalls of the cavity 524), and may be further transmitted through a portion of the body of the optical connector 510 (e.g., part of the second portion 540 of the body of the optical connector 510) to the second optical fibers 568. The shape, size, configuration, and/or material of the lenses 552A and 552B may be selected such that optical signals 557 are collimated, diffused, and/or focused as needed for a given application, or to allow for optical signals 557 of a desired quality or character to be obtained (e.g., at the second optical fibers 568 and/or an external optical component optically connected to the second optical fibers 568).

Still other embodiments are possible and are within the scope of the present disclosure. For example, FIG. 7D shows a cross-sectional view of an alternative example optical assembly. As shown in FIG. 7D, the first portion 520 of the body of the optical connector 510 may include a leading (e.g., front) section 520A and a trailing (e.g., back or rear) section 520B, where a wall 520C of the leading section 520A defining a first end of the first portion 520 facing the optical bridge structure 508 (e.g., a wall 520C of the leading section 520A including the apertures or openings 538) may be farther from the first connector interface 510A than a wall 520D of the trailing section 520B defining a second end of the first portion 520 facing the optical bridge structure 508 (e.g., a wall 520D of the trailing section 520B at least in part defining the cavity 524). The optical bridge structure 508 may include a leading (e.g., front) section 508A that interfaces with the wall 520D of the trailing section 520B and a trailing (e.g., back or rear) section 508B that interfaces with the wall 520C of the leading section 520A. The optical bridge structure 508 may include a cavity 524 with a lens 528 that may be integral with a wall of the optical bridge structure 508 defining the cavity 524. Optical signals 549 may be transmitted along an optical path, along which the optical signals 549 may be transmitted from the first optical fibers 564 towards the optical bridge structure 508 (e.g. to the leading section 508A of the optical bridge structure 508). The optical signals 549 may be transmitted from the first optical fibers 564 and through a portion of the body of the optical connector 510 (e.g., through a portion of the second portion 540 of the body) to a lens 548 (e.g., in recess 546) of a sidewall of the cavity 524. The optical signals 549 may be transmitted from the lens 548 and through the optical isolator 580 and lens 528 (e.g., in recess 526) to the optical bridge structure 508 (e.g., the leading section 508A of the optical bridge structure 508).

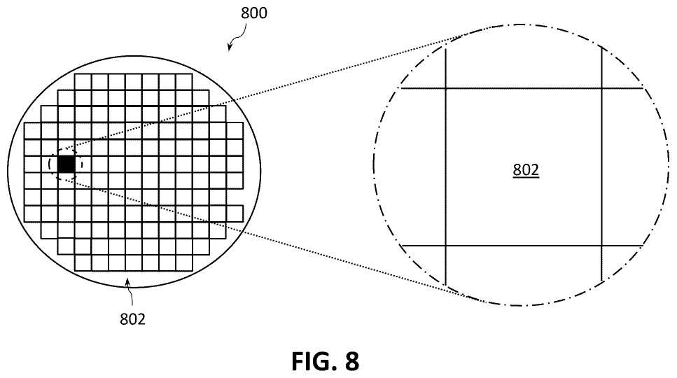

Arrangements with one or more optical assemblies (e.g., optical assemblies 100, 200, 300, 500, 600, or other optical assemblies disclosed herein) may be included in any suitable component or electronic, photonic, or co-packaged device. Sub-assemblies of the optical assemblies disclosed herein, including one or more optical connectors 270, 510 (which may include one or more optical isolators 580) may also be included in any suitable component or electronic, photonic, or co-packaged device. The optical assemblies and sub-assemblies noted above may be referred as optical structures hereinafter. FIGS. 8-10 illustrate various examples of devices and components that may include one or more optical structures as disclosed herein.

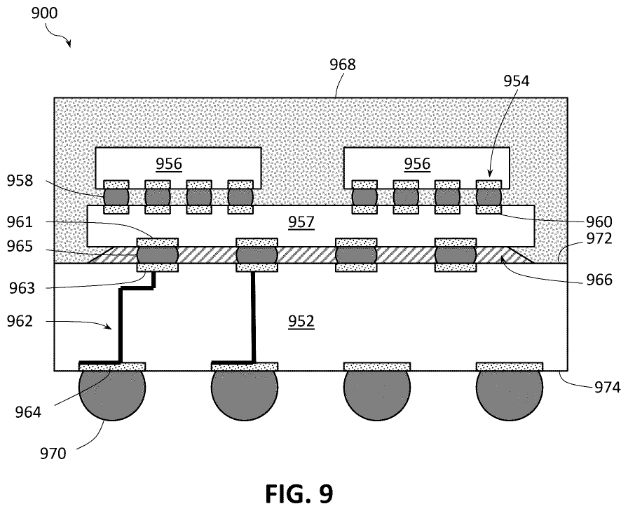

FIG. 8 illustrates top views of a wafer 800 and dies 802 that may be included in one or more optical structures in accordance with any of the embodiments disclosed herein. In some embodiments, the dies 802 may be included in an IC package (e.g., including a PIC package), in accordance with any of the embodiments disclosed herein. For example, any of the dies 802 may be included in, or serve as, the optical component 110 (e.g., a PIC die) or any of the components 114 shown in FIG. 1. In another example, any of the dies 802 may serve as any of the dies 956 in an IC package 900 shown in FIG. 9. The wafer 800 may be composed of semiconductor material and may include one or more dies 802 having IC structures formed on a surface of the wafer 800. Each of the dies 802 may be a repeating unit of a semiconductor product that includes any suitable IC (e.g., ICs including one or more PICs as described herein, e.g., the optical component 110 of FIG. 1). At least some of the dies 802 may be attached to, or be included in, one or more optical structures described herein. After the fabrication of the semiconductor product is complete, the wafer 800 may undergo a singulation process in which each of the dies 802 is separated from one another to provide discrete “chips” of the semiconductor product. In particular, devices that are attached to, or included in, one or more optical structures as disclosed herein may take the form of the wafer 800 (e.g., not singulated) or the form of the die 802 (e.g., singulated). The die 802 may include supporting circuitry to route electrical and/or optical signals to various components, e.g., to various optical structures, as well as to various transistors, capacitors, resistors, or any other IC components within the die 802.

FIG. 9 is a side, cross-sectional view of an example microelectronic package 900 that may include one or more optical structures in accordance with any of the embodiments disclosed herein. In some embodiments, the microelectronic package 900 may be a system-in-package (SiP).

The package substrate 952 may be formed of a dielectric material (e.g., a ceramic, a buildup film, an epoxy film having filler particles therein, etc.), and may have conductive pathways 962 extending through the dielectric material between the face 972 and the face 974, or between different locations on the face 972, and/or between different locations on the face 974.

The package substrate 952 may include conductive contacts 963 that are coupled to conductive pathways 962 through the package substrate 952, allowing circuitry within the dies 956 and/or the interposer 957 to electrically couple to various ones of the conductive contacts 964 (or to other devices included in the package substrate 952, not shown).

The microelectronic package 900 may include an interposer 957 coupled to the package substrate 952 via conductive contacts 961 of the interposer 957, first-level interconnects 965, and the conductive contacts 963 of the package substrate 952. The first-level interconnects 965 illustrated in FIG. 9 are solder bumps, but any suitable first-level interconnects 965 may be used. In some embodiments, no interposer may be included in the microelectronic package 900; instead, the dies 956 may be coupled directly to the conductive contacts 963 at the face 972 by first-level interconnects 965.

The microelectronic package 900 may include one or more dies 956 coupled to the interposer 957 via conductive contacts 954 of the dies 956, first-level interconnects 958, and conductive contacts 960 of the interposer 957. The conductive contacts 960 may be coupled to conductive pathways (not shown) through the interposer 957, allowing circuitry within the dies 956 to electrically couple to various ones of the conductive contacts 961 (or to other devices included in the interposer 957, not shown). The first-level interconnects 958 illustrated in FIG. 9 are solder bumps, but any suitable first-level interconnects 958 may be used. As used herein, a “conductive contact” may refer to a portion of electrically conductive material (e.g., metal) serving as an interface between different components; conductive contacts may be recessed in, flush with, or extending away from a surface of a component, and may take any suitable form (e.g., a conductive pad or socket).

In some embodiments, an underfill material 966 may be disposed between the package substrate 952 and the interposer 957 around the first-level interconnects 965, and a mold compound 968 may be disposed around the dies 956 and the interposer 957 and in contact with the package substrate 952. In some embodiments, the underfill material 966 may be the same as the mold compound 968. Example materials that may be used for the underfill material 966 and the mold compound 968 are epoxy mold materials, as suitable. Second-level interconnects 970 may be coupled to the conductive contacts 964. The second-level interconnects 970 illustrated in FIG. 9 are solder balls (e.g., for a ball grid array arrangement), but any suitable second-level interconnects 970 may be used (e.g., pins in a pin grid array arrangement or lands in a land grid array arrangement). The second-level interconnects 970 may be used to couple the microelectronic package 900 to another component, such as a circuit board (e.g., a motherboard), an interposer, or another IC package, as known in the art.

The dies 956 may take the form of any of the embodiments of the die 802 discussed herein. In embodiments in which the microelectronic package 900 includes multiple dies 956, the microelectronic package 900 may be referred to as a multi-chip package (MCP). The dies 956 may include circuitry to perform any desired functionality. In some embodiments, any of the dies 956 may be attached to, or included in, one or more optical structures as discussed above; in some embodiments, at least some of the dies 956 may not be attached to or included in any optical structures.

The microelectronic package 900 illustrated in FIG. 9 may be a flip chip package, although other package architectures may be used. For example, the microelectronic package 900 may be a ball grid array (BGA) package, such as an embedded wafer-level ball grid array (eWLB) package. In another example, the microelectronic package 900 may be a wafer-level chip scale package (WLCSP) or a panel fan-out (FO) package. Although two dies 956 are illustrated in the microelectronic package 900 of FIG. 9, a microelectronic package 900 may include any desired number of the dies 956. A microelectronic package 900 may include additional passive components, such as surface-mount resistors, capacitors, and inductors disposed on the first face 972 or the second face 974 of the package substrate 952, or on either face of the interposer 957. More generally, a microelectronic package 900 may include any other active or passive components known in the art.

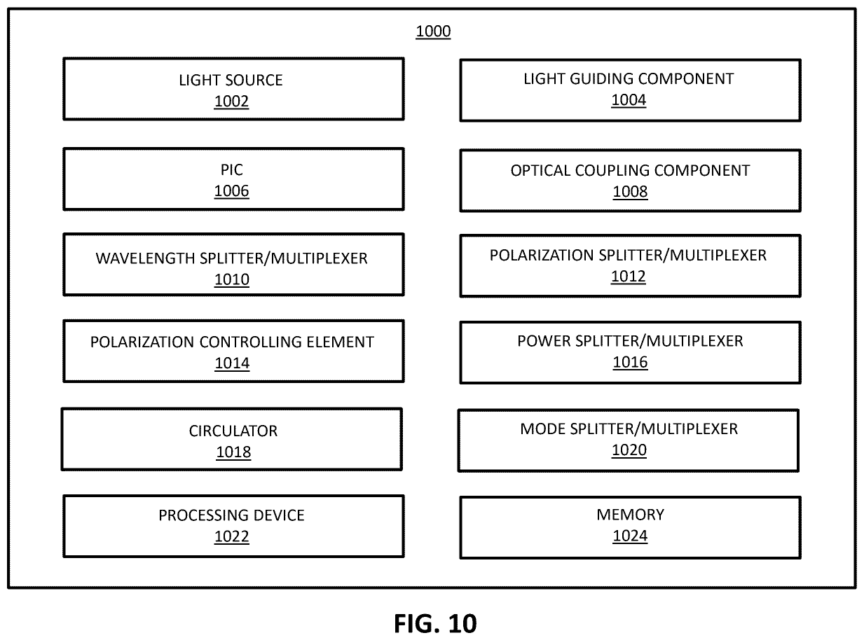

FIG. 10 is a block diagram of an example photonic device 1000 that may include one or more components in which one or more optical structures may be implemented. For example, any suitable ones of the components of the photonic device 1000 may include a die (e.g., the die 802 of FIG. 8) having one or more microelectronic packages (e.g., microelectronic packages 900 of FIG. 9).

A number of components are illustrated in FIG. 10 as included in the photonic device 1000, but any one or more of these components may be omitted or duplicated, as suitable for the application. In some embodiments, some or all of the components included in the photonic device 1000 may be attached to one or more motherboards or any suitable support structure. In some embodiments, some or all of these components are fabricated onto a single system-on-chip (SoC) die. Additionally, in some embodiments, the photonic device 1000 may not include one or more of the components illustrated in FIG. 10, but the photonic device 1000 may include interface circuitry for coupling to the one or more components. For example, the photonic device 1000 may not include a processing device 1022, but may include processing device interface circuitry (e.g., a connector and driver circuitry) to which a processing device 1022 may be coupled. In another example, the photonic device 1000 may not include a memory 1024, but may include memory interface circuitry (e.g., connectors and supporting circuitry) to which a memory 1024 may be coupled. In yet another example, the photonic device 1000 may not include a circulator 1018, but may include circulator interface circuitry (e.g., connectors) to which a circulator 1018 may be coupled.

In some embodiments, the photonic device 1000 may include at least one light source 1002. The light source 1002 may include any suitable device for providing the necessary optical signals for various applications of the photonic device 1000, ranging from communication to sensing and imaging. The light source 1002 may be designed to emit light in a controlled and efficient manner to meet the specific requirements of the photonic device 1000. In some embodiment, the light source 1002 may be a coherent and monochromatic light source such as a laser, to produce light of a well-defined wavelength, low divergence, and high brightness. Examples of lasers that may be included in the light source 1002 include semiconductor lasers, such as edge-emitting lasers and vertical-cavity surface-emitting lasers (VCSELs). Such lasers may be particularly advantageous when the photonic device 1000 is used in applications like optical communication, sensing, and laser-based treatments in medical devices. In some embodiment, the light source 1002 may be a non-coherent light source such as a light-emitting diode (LED) that emits light when an electric current is applied. LEDs may be simpler and more cost-effective than lasers, making them suitable for applications where high coherence is not required. Using an LED as the light source 1002 may be particularly advantageous when the photonic device 1000 is used in applications like displays, optical sensors, and short-distance communication systems. In further embodiments, the light source 1002 may include one or more of a superluminescent diode (SLD), a quantum dot, a rare-earth-doped fiber/waveguide, a plasma source (e.g., plasmonics and microplasma devices), a microcavity resonator, or a nonlinear optical device (e.g., a photonic device that uses nonlinear optical processes, such as frequency doubling or parametric amplification, to generate new wavelengths).

In some embodiments, the photonic device 1000 may include at least one light guiding component 1004, such as a waveguide, to manipulate and control the propagation of light. The light guiding component 1004 may include any suitable waveguide structures designed to confine and guide light along a specified path, allowing it to travel from one point to another with minimal loss and dispersion. Examples of waveguides that may be used as the light guiding component 1004 include planar waveguides, optical fibers, photonic crystal waveguides, and rib waveguides. In some embodiments, the light guiding component 1004 may include a material with a higher refractive index, known as the “core,” surrounded by a material with a lower refractive index, known as the “cladding.” The refractive index contrast between the core and cladding helps guide light within the core by using total internal reflection. Light is trapped within the core due to its reflection at the core-cladding interface. The light guiding component 1004 may support various modes of light propagation, such as single-mode or multimode.

In some embodiments, the photonic device 1000 may include at least one PIC 1006. A PIC 1006 may be a miniaturized and integrated optical device that incorporates photonic components, such as optical modulators, photodetectors, and waveguides, onto a single substrate. In some embodiments, the PIC 1006 may include one or more optical modulators for encoding data onto an optical signal, e.g., onto light generated by the light source 1002. An optical modulator of the PIC 1006 may change certain properties of an optical signal, such as its amplitude, frequency, or phase, in order to encode information onto the signal or to perform various signal processing functions. Examples of optical modulators that may be implemented in the PIC 1006 include electro-optic modulators, Mach-Zehnder Interferometric (MZI) modulators, or microring modulators. In some embodiments, the PIC 1006 may include one or more photodetectors for detecting and measuring the intensity of light or optical radiation across various wavelengths by converting incident light/photons into an electrical signal. Examples of photodetectors that may be implemented in the PIC 1006 include photodiodes, avalanche photodiodes, phototransistors, PIN diodes, CMOS image sensors, photomultiplier tubes, or quantum photodetectors. In some embodiments, the PIC 1006 may include one or more waveguides, e.g., any of the waveguides described with reference to the light guiding component 1004.

In some embodiments, the photonic device 1000 may include at least one optical coupling component 1008. The optical coupling component 1008 may include any suitable structures designed to facilitate efficient transfer of light between different optical devices, e.g., between the light source 1002 and the light guiding component 1004, between the light source 1002 and the PIC 1006, between the light guiding component 1004 and the PIC 1006, or between the light guiding component 1004 or the PIC 1006 and a further transmission line such as a fiber (not shown in FIG. 10) that may be coupled to the PIC 1006. Examples of optical coupling elements that may be used to implement the optical coupling component 1008 include fiber couplers (e.g., fused fiber couplers or tapered fiber couplers), waveguide couplers, grating couplers, lens couplers, microlens couplers, prism couplers, fiber array couplers, or ball lens couplers. In some embodiment, the optical coupling component 1008 may include one or more optical structures as described herein.

In some embodiments, the photonic device 1000 may include at least one wavelength splitter/multiplexer 1010, to combine or split multiple optical signals that are carried at different wavelengths. This may be particular advantageous if the photonic device 1000 is used in an optical communication system such as a wavelength division multiplexing (WDM) system or a dense wavelength division multiplexing (DWDM) system, where multiple data channels are transmitted simultaneously over a single optical fiber using different wavelengths of light. In some embodiments, the wavelength splitter/multiplexer 1010 may include a wavelength division multiplexer, a wavelength division demultiplexer, a passive optical add/drop multiplexer, an arrayed waveguide grating, a fused fiber couplers, and interleavers, or an optical filter-based device.

In some embodiments, the photonic device 1000 may include at least one polarization splitter/multiplexer 1012, to combine or split multiple optical signals depending on their polarization. Similarly, in some embodiments, the photonic device 1000 may include at least one polarization controlling component 1014, to control polarization of light generated and manipulated in the photonic device 1000. In some embodiments, a polarization splitter/multiplexer 1012 and a polarization controlling component 1014 may include any suitable structure to enable the manipulation and management of polarized light signals, such as birefringent materials, waveguide structures, or specialized coatings that interact differently with different polarization states.

In some embodiments, the photonic device 1000 may include at least one general power splitter/multiplexer 1016, to combine or split multiple optical signals that in a manner that is not dependent on wavelength or polarization. For example, in some embodiments, a power splitter/multiplexer 1016 may be used to tap off a small amount of optical power for various purposes, such as optical signal or power monitoring in the photonic device 1000. Examples of devices that may be used as a power splitter/multiplexer 1016 include directional couplers and multimode interference couplers.

In some embodiments, the photonic device 1000 may include at least one circulator 1018, also referred to as a “directional splitter.” The circulator 1018 may include any suitable device configured to direct light signals to travel in a specific, one-way circular path through its ports. In some embodiments, the circulator 1018 may include magneto-optic materials or other techniques that create a Faraday rotation effect, where the polarization of light is rotated as it passes through the circulator 1018.

In some embodiments, the photonic device 1000 may include at least one mode splitter/multiplexer 1020, to combine or split multiple optical signals based on their guided modes. Examples of devices that may be used as a mode splitter/multiplexer 1020 include directional couplers, multimode interference couplers, tapered waveguide couplers, photonic lanterns, or photonic crystal splitters.

In some embodiments, the photonic device 1000 may include a processing device 1022 (e.g., one or more processing devices). As used herein, the term “processing device” or “processor” may refer to any device or portion of a device that processes electronic data from registers and/or memory to transform that electronic data into other electronic data that may be stored in registers and/or memory. The processing device 1022 may include one or more digital signal processors (DSPs), application-specific integrated circuits (ASICs), CPUs, GPUS, cryptoprocessors (specialized processors that execute cryptographic algorithms within hardware), server processors, or any other suitable processing devices. In some embodiments, the processing device 1022 may include circuitry to control operation of other components of the photonic device 1000, e.g., to control operation of the PIC 1006.

In some embodiments, the photonic device 1000 may include a memory 1024, which may itself include one or more memory devices such as volatile memory (e.g., DRAM), nonvolatile memory (e.g., read-only memory (ROM)), flash memory, solid state memory, and/or a hard drive. In some embodiments, the memory 1024 may include memory that shares a die with the processing device 1022. This memory may be used as cache memory and may include embedded DRAM (eDRAM) or spin transfer torque magnetic random-access memory (MRAM). In some embodiments, the memory 1024 may store instructions or data for the processing device 1022 to control operation of other components of the photonic device 1000, e.g., to control operation of the PIC 1006.

The following paragraphs provide various examples of the embodiments disclosed herein.

Example 1 provides an optical connector, including a body including a first connector interface, a second connector interface opposite the first connector interface, and a surface between the first connector interface and the second connector interface; a cavity extending from the surface into the body; and an opening in the body, the opening extending from the first connector interface towards the cavity, where a portion of the body separates the cavity and the opening.

Example 2 provides the optical connector of example 1, where the opening is for receiving an optical fiber for providing an optical signal from the first connector interface to the second connector interface, and where at least a portion of the cavity is in an optical path of the optical signal.

Example 3 provides the optical connector of examples 1 or 2, further including a lens in the cavity, the lens substantially aligned with the opening (e.g., the lens has an optical axis that is substantially aligned with an optical axis of the opening, or the lens is substantially optically aligned with the opening).

Example 4 provides the optical connector of example 3, where the cavity has a sidewall, and where the lens is at the sidewall (e.g., the lens being a part of the sidewall, or the lens being in contact with the sidewall, or the lens being attached to the sidewall).

Example 5 provides the optical connector of example 4, where the sidewall is substantially perpendicular to the surface.

Example 6 provides the optical connector of examples 4 or 5, where the lens is integrated into the sidewall.

Example 7 provides the optical connector of any one of examples 4-6, where the sidewall has a recess and the lens is in the recess.

Example 8 provides the optical connector of example 7, where a depth of the recess is between about 1 and about 100 microns.

Example 9 provides the optical connector of any one of examples 4-8, where the sidewall is a first sidewall, and the cavity further includes a second sidewall.

Example 10 provides the optical connector of example 9, where the first sidewall is substantially opposite the second sidewall.

Example 11 provides the optical connector of examples 9 or 10, where the lens is a first lens, and the optical connector further includes a second lens at the second sidewall.

Example 12 provides the optical connector of example 11, where the second lens is integrated into the second sidewall.

Example 13 provides the optical connector of examples 11 or 12, where the second lens is substantially aligned with the opening.

Example 14 provides the optical connector of any one of examples 11-13, where the second lens is substantially aligned with the first lens.

Example 15 provides the optical connector of any one of examples 11-14, where the second sidewall has a recess and the second lens is in the recess.

Example 16 provides the optical connector of any one of examples 9-15, where the second sidewall is substantially perpendicular to the surface.

Example 17 provides the optical connector of any one of examples 9-16, where the first sidewall is substantially parallel to the second sidewall.

Example 18 provides the optical connector of any one of examples 9-17, where the first sidewall is closer to the opening than the second sidewall.

Example 19 provides the optical connector of any one of examples 9-17, where the second sidewall is closer to the opening than the first sidewall.

Example 20 provides the optical connector of any one of examples 1-19, where a distance between the cavity and the opening is between about 1 and about 100 microns.

Example 21 provides the optical connector of any one of examples 1-20, where a distance between the cavity and the opening is between about 1% and about 50% of a distance between the first connector interface and the second connector interface.

Example 22 provides the optical connector of any one of examples 1-21, where a distance between the cavity and the second connector interface is between about 1 and about 100 microns.

Example 23 provides the optical connector of any one of examples 1-22, where a distance between the cavity and the second connector interface is between about 1% and about 50% of a distance between the first connector interface and the second connector interface.

Example 24 provides the optical connector of any one of examples 1-23, where the second connector interface has a depression, and where a portion of the body separates the cavity and the depression.

Example 25 provides the optical connector of example 24, where the depression extends from the surface into the body.

Example 26 provides the optical connector of examples 24 or 25, where the depression is substantially aligned with the opening.

Example 27 provides the optical connector of any one of examples 24-26, where a depth of the depression is between about 1 and about 100 microns.

Example 28 provides the optical connector of any one of examples 24-27, where a depth of the depression is between about 1% and about 50% of a length of the second connector interface.

Example 29 provides the optical connector of any one of examples 1-28, where: the body includes a first portion and a second portion attached to the first portion, a first portion of the cavity is a recess in the first portion of the body, and a second portion of the cavity is a recess in the second portion of the body.

Example 30 provides the optical connector of any one of examples 1-28, where the body is a monolithic structure.

Example 31 provides the optical connector of any one of examples 1-30, where the opening is a first opening, and where the optical connector further includes a second opening in the body, the second opening extending from the first connector interface towards the second connector interface.

Example 32 provides the optical connector of example 31, where the second opening extends through the body between the first connector interface and the second connector interface.

Example 33 provides the optical connector of example 31, where the second opening extends only partway between the first connector interface and the second connector interface.

Example 34 provides the optical connector of example 33, where the second opening extends towards the cavity, and where a further portion of the body separates the cavity and the second opening.

Example 35 provides the optical connector of any one of examples 31-34, where the second opening is for receiving an optical fiber for providing an optical signal from the second connector interface to the first connector interface.

Example 36 provides the optical connector of example 4, where: the lens is a first lens, the sidewall is a first sidewall, the optical connector further includes a second lens in the cavity, the second lens is substantially aligned with the opening, and the second lens is at a second sidewall of the cavity.

Example 37 provides the optical connector of example 36, where the first sidewall has a recess and the first lens is in the recess.

Example 38 provides the optical connector of example 36, where the second sidewall has a recess and the second lens is in the recess.

Example 39 provides the optical connector of example 36, where the first sidewall has a first recess, the second sidewall has a second recess, the first lens is in the first recess, and the second lens is in the second recess.

Example 40 provides the optical connector of example 39, where a depth of the first recess is different from a depth of the second recess.

Example 41 provides the optical connector of example 39, where a depth of the first recess is substantially similar to a depth of the second recess.

Example 42 provides the optical connector of any one of examples 1-41, further including an optical isolator in the cavity.

Example 43 provides an optical assembly, including a structure including a first side, a second side opposite the first side, and a surface between the first side and the second side; an opening extending from the surface into the structure, the opening having a sidewall and a lens at the sidewall; and a channel in the structure, the channel extending from the first side towards the opening, where a portion of the structure separates the opening and the channel (or, where the channel is spaced apart from the opening).

Example 44 provides the optical assembly of example 43, where the channel is substantially aligned with the lens.

Example 45 provides the optical assembly of examples 43 or 44, where the lens is in an alcove of the sidewall.

Example 46 provides the optical assembly of any one of examples 43-45, where the sidewall is a first sidewall, the lens is a first lens, the opening has a second sidewall substantially opposite the first sidewall, and a second lens is at the second sidewall.

Example 47 provides the optical assembly of example 46, where the first lens is substantially aligned with the second lens.

Example 48 provides the optical assembly of any one of examples 43-47, further including an optical isolator in the opening.

Example 49 provides the optical assembly of any one of examples 43-48, where the opening is a blind opening.

Example 50 provides an optical connector assembly, including an optical connector including a first end, a second end opposite the first end, and an outer portion between the first end and the second end; a shaft extending from the outer portion into the optical connector; and an aperture in the optical connector, the aperture extending from the first end towards the shaft, where a portion of the optical connector separates the shaft and the aperture, the aperture is for receiving an optical fiber for providing an optical signal from the first end to the second end, and at least a portion of the shaft is in an optical path of the optical signal.

Example 51 provides the optical connector assembly of example 50, further including a lens in the shaft, the lens substantially aligned with the aperture.

Example 52 provides the optical connector assembly of examples 50 or 51, where the shaft is a blind shaft.

Example 53 provides the optical connector assembly of any one of examples 50-52, further including an optical isolator in the shaft.

1. An optical connector, comprising:
a body comprising a first connector interface, a second connector interface opposite the first connector interface, and a surface between the first connector interface and the second connector interface;
a cavity extending from the surface into the body;
a lens in a recess in a sidewall of the cavity, and
an opening in the body, the opening extending from the first connector interface towards the cavity, wherein a portion of the body separates the cavity and the opening.

2. The optical connector of claim 1, wherein at least a portion of the cavity is in an optical path of an optical signal to travel from the first connector interface to the second connector interface.

3. The optical connector of claim 1, wherein the lens is substantially aligned with the opening.

4. The optical connector of claim 1, wherein the sidewall is substantially perpendicular to the surface.

5. The optical connector of claim 1, wherein a distance between the cavity and the opening is between about 1% and about 50% of a distance between the first connector interface and the second connector interface.

6. The optical connector of claim 1, wherein the sidewall is a first sidewall, the lens is a first lens, and the optical connector further includes a second sidewall substantially opposite the first sidewall and a second lens at the second sidewall.

7. The optical connector of claim 6, wherein the second lens is substantially aligned with the opening.

8. The optical connector of claim 6, wherein the second lens is substantially aligned with the first lens.

9. The optical connector of claim 1, wherein the second connector interface has a depression, and wherein a portion of the body separates the cavity and the depression.

10. The optical connector of claim 9, wherein the depression extends from the surface into the body.

11. The optical connector of claim 1, wherein:
the body includes a first portion and a second portion attached to the first portion,
a first portion of the cavity is a recess in the first portion of the body, and
a second portion of the cavity is a recess in the second portion of the body.

12. The optical connector of claim 1, wherein the opening is a first opening, and wherein the optical connector further includes a second opening in the body, the second opening extending from the first connector interface towards the second connector interface.

13. The optical connector of claim 12, wherein the second opening extends through the body between the first connector interface and the second connector interface.

14. An optical assembly, comprising:
a structure comprising a first side, a second side opposite the first side, and a surface between the first side and the second side;
an opening extending from the surface into the structure, the opening having a sidewall and a lens at the sidewall; and
a channel in the structure, the channel extending from the first side towards the opening, wherein the channel is spaced apart from the opening.

15. The optical assembly of claim 14, wherein the sidewall is a first sidewall, the lens is a first lens, the opening has a second sidewall substantially opposite the first sidewall, and a second lens is at the second sidewall.

16. The optical assembly of claim 15, wherein the first lens is substantially aligned with the second lens.

17. The optical assembly of claim 14, wherein the opening is a blind opening.

18. An optical connector assembly, comprising:
an optical connector comprising a first end, a second end opposite the first end, and an outer portion between the first end and the second end;
a shaft extending from the outer portion into the optical connector; and
an aperture in the optical connector, the aperture extending from the first end towards the shaft, wherein a portion of the optical connector separates the shaft and the aperture, the aperture is for receiving an optical fiber for providing an optical signal from the first end to the second end, and at least a portion of the shaft is in an optical path of the optical signal.

19. The optical connector assembly of claim 18, further comprising a lens in the shaft, the lens substantially aligned with the aperture.

20. The optical connector assembly of claim 18, further including an optical isolator in the shaft.
